(19) United States
(12) Patent Application Publication
(10) Pub. No.: US 2014/0379868 A1
(43) Pub. Date: Dec. 25, 2014

(54) HOME SCOREBOARD SYNCHRONIZED IN REAL-TIME TO GAME-SPECIFIC DATA

(71) Applicants: Will NAULT, Stony Plain (CA); Tyler RICHARDS, St. Albert (CA)

(72) Inventors: Will NAULT, Stony Plain (CA); Tyler RICHARDS, St. Albert (CA)

(21) Appl. No.: 14/307,041

(22) Filed: Jun. 17, 2014

Related U.S. Application Data
(60) Provisional application No. 61/835,826, filed on Jun. 17, 2013.

(51) Int. Cl. H04L 29/06; G06F 17/30; H04L 29/08

(52) U.S. Cl. CPC H04L 65/4076; H04L 67/06; G06F 17/30165
USPC 709/219

(57) ABSTRACT

A system delivers game-specific data via a network from a database to a home scoreboard, which displays the data to its user. In response to receiving an order linked to the home scoreboard via the network from a network-connected device, the system retrieves the data from a database and transmits the data to the home scoreboard in real-time. Upon receiving the data, the display configures the display to display the data in real-time. The home scoreboard has a transparent fascia that covers the display, while allowing its display fields to be visible to its user. The home scoreboard also has a light source that illuminates in response to receiving data indicative of a specified game event.

### CROSS REFERENCE TO RELATED APPLICATIONS

This application claims the priority benefit of U.S. Provisional Application No. 61/835,826 filed on Jun. 17, 2013 entitled “Home Entertainment System”, the entire contents of which are incorporated by reference.

### FIELD OF THE INVENTION

The present invention relates to a home entertainment system, and in particular, a home scoreboard synchronized in real-time to game-specific data.

### BACKGROUND OF THE INVENTION

Major league sports enjoy a wide audience, with many fans devoted to their sport and their teams. However, many fans are not able to attend live games and their participation is limited to watching events on television,

Many televised sporting events include secondary information about the event, such as a time clock and score display, which is typically shown in a small window in the corner of the televised shot. In some cases, additional information about the game, or other sporting events are shown in a news ticker which scrolls across the bottom of the screen. While useful, these secondary sources of information do little to enhance the viewer's experience.

Therefore, there is a need in the art for methods and systems to enhance the home viewing experience of fans watching sporting events on television.

### SUMMARY OF THE INVENTION

In one aspect, the present invention provides a home scoreboard configured for use in a private residence for receiving game-specific data via a network and displaying the data. The home scoreboard comprises:
(a) a display comprising at least one display field for displaying the data;
(b) a communications link for receiving the data via the network; and
(c) a processor operatively connected to the display, the communications link, and a memory storing a set of instructions, wherein the processor is responsive to the set of instructions to automatically execute a method comprising the steps of:
   (i) receiving the data at the processor directly or indirectly from the network; and
   (ii) upon receiving the data at the processor, configuring the display to display the data.
      In one embodiment, the data is displayed in real-time to its reception at the processor, and preferably in real-time to the actual occurrence of the game-specific data.

In one embodiment, the home scoreboard further comprises a housing that retains the display; and a fascia covering the display, wherein the fascia comprises at least one transparent portion aligned with the at least one display field to allow the at least one display field to be viewed. The fascia may be removably attached to the housing, such as by the use of a magnet or other conveniently removable fastener.

In one embodiment, the home scoreboard further comprises a light source, wherein the processor is operatively connected to the light source, and the method comprises the further step of illuminating the light source in response to receiving data indicative of specified game information. The light source may be an LED light strip. The LED light strip may comprise a plurality of emitters that emit light of different colors, and wherein the processor selectively illuminates emitters depending on the data,

In one embodiment, the step of receiving the data at the processor comprises receiving the data directly from the network via the communications link.

In one embodiment, the received data is stored in a memory component for replay at a later time, and the processor is operatively linked by the communications link to a video recording and playback device to synchronize the replay of the stored data and the playback of a recorded game broadcast.

In one embodiment, the step of receiving the data at the processor comprises receiving the data indirectly from the network by analyzing a recorded broadcast file for any auditory or visual cues indicative of the data and generating the data from the cues, upon playback of the stored broadcast file, originally transmitted via the network.

In another aspect, the present invention provides a system for delivering game-specific data over a network from a database to a home scoreboard in response to an order from a network-connected device, the order being linked to the home scoreboard. The system comprises:
(a) a processor operatively connected to the network and the database; and
(b) a memory storing a set of instructions, wherein the processor is responsive to the set of instructions to automatically execute a method comprising the steps of:
   (i) receiving the order for the data via the network;
   (ii) in response to the order, retrieving the data from the database; and
   (iii) transmitting the data via the network, directly or indirectly, to the home scoreboard in real-time to its reception.

In one embodiment of the system, the step of transmitting the data via the network comprises transmitting a broadcast file containing the data.

In another aspect, the present invention provides a method of providing game-specific data over a network to a customer. The method is implemented by a processor connected to the network and comprises the steps of:
(a) receiving an order for game-specific data from a network-connected device;
(b) in response to the order, retrieving the data from a database; and
(c) transmitting the data to a home scoreboard linked to the order.

In one embodiment of the method, the step of transmitting the data via the network comprises transmitting a broadcast file containing the data.

### BRIEF DESCRIPTION OF THE DRAWINGS

In the drawings, like elements are assigned like reference numerals. The drawings are not necessarily to scale, with the emphasis instead placed upon the principles of the present invention. Additionally, each of the embodiments depicted are but one of a number of possible arrangements utilizing the fundamental concepts of the present invention. The drawings are briefly described as follows:

FIG. 1 is a front perspective view of one embodiment of a home scoreboard of the present invention.

FIG. 2 is an exploded view of another embodiment of a home scoreboard of the present invention.

FIG. 3 is a front view of another embodiment of a home scoreboard of the present invention, with its fascia removed.

FIG. 4 is a side view of the embodiment of the home scoreboard shown in FIG. 3, with its fascia removed.

FIG. 5 is a front view of the fascia of the embodiment of the home scoreboard shown in FIG. 3.

FIG. 6 is a schematic view of one embodiment of a system of the present invention for delivering game-specific information to a home scoreboard.

### DETAILED DESCRIPTION OF PREFERRED EMBODIMENTS OF THE INVENTION

The present invention relates to a sports-related home entertainment system, and in particular, a home scoreboard synchronized in real-time to game-specific data. Any term or expression not expressly defined herein shall have its commonly accepted definition understood by those skilled in the art.

As used herein, the term “real-time” means that the time elapsed from an input to a processor, and the processor producing a corresponding output, is sufficiently small so that, for all practical purposes, the output appears to be synchronized with the input.

As used herein, the term “game-specific data” means information indicative of a state of a particular sports game and may include, without limitation, an identity of the competitor or competitors, a performance parameter of a competitor in the sporting event such as a score, a time of game or time remaining in a game, or any other statistical information of interest to a sports fan.

In one aspect, the invention provides a home scoreboard. As used herein, the term “home scoreboard” means a device which is configured for use in a private residence and replicates the scoreboard experience at a live sporting event.

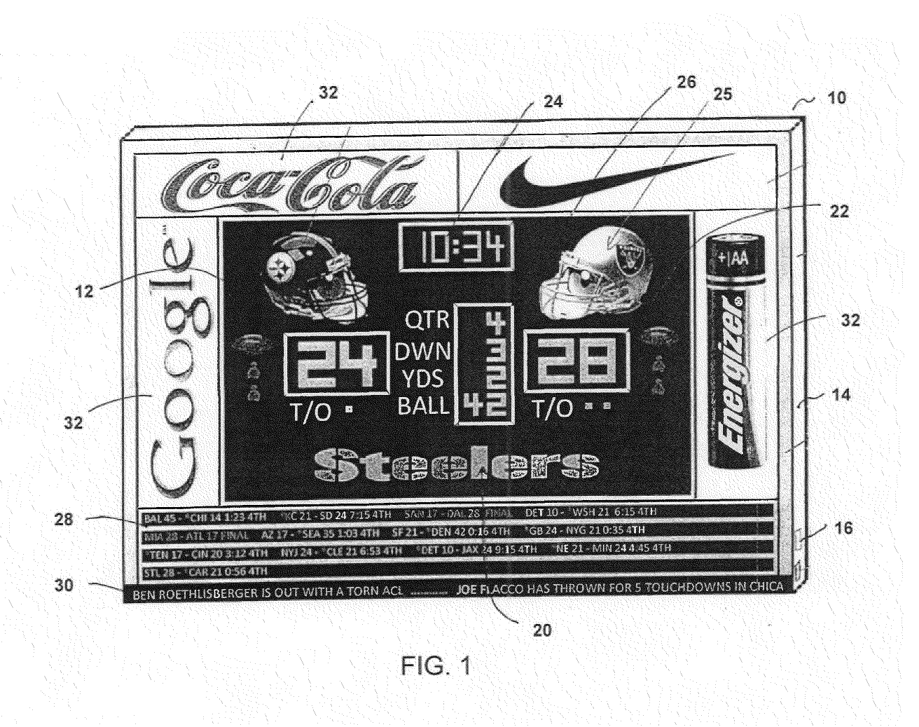

The home scoreboard (10) includes at least one display (12), a processor (14) and a communications link (16) all of which are operatively connected to each other. In one embodiment, as shown in FIG. 1, the display (12), processor (14) and communications link (16) are physically integrated within a single unit. The size of the home scoreboard is suitable for home use; as a non-limiting example, the home scoreboard (10) may have dimensions about 32 inches×22 inches×3 inches (width by height by depth).

The display (12) provides a visual output of the game-specific data. The display (12) may be any suitable display. In one embodiment, the display (12) may comprise one or more LCDs, LEDs or a plasma display, similar to a flat panel television set or computer monitor. In another embodiment, the display may comprise a plurality of discrete display units or blocks, such as conventional seven-segment LED displays, which can display numeric or rudimentary alphanumeric information. The display units or blocks may comprise more complex dot matrix displays if desired.

The communications link (16) provides a data connection to a sports data source over a network, such as the Internet, to receive the game-specific data in real-time. In one embodiment, the communications link (16) comprises a WiFi, or Bluetooth™ receiver wirelessly connected to a modem which connects to a broadband access network or a cellular wireless network, such as a 3G or a 4G radio system. The communications link (16) may also comprise a receiver for a cable television transmission, such as a digital video feed.

The processor (14) may comprise any hardware, software or firmware, or combinations thereof, which is operative to receive and process the game-specific data from the communications link (16), and to configure the display (12) to provide a visual output of the game-specific data in real-time. In one embodiment, the processor (14) comprises a printed circuit board (PCB).

The home scoreboard (10) may comprise an internal rechargeable battery, or be powered by a DC power input, or an AC power input or combinations thereof.

In one embodiment, as shown in FIG. 1, the home scoreboard (10) is configured to closely resemble a stadium or arena scoreboard and display game-specific information associated with the Pittsburgh Steelers™ football team of the National Football League™ Thus, the home scoreboard (10) displays that team's identifying name (20), logo, colors, uniforms, and/or products. In one embodiment, the team or sport-specific information may be permanent and an integral part of the scoreboards. In another embodiment, the team or sport-specific information may be part of interchangeable front covers, so that a user can adapt the scoreboard to a particular team, game or sport.

The display (12) includes a variety of display fields. They include the game score (22) of each team in association with each team's identifiers (25) (e.g., football helmets (25)) on opposing halves of the display. Other display fields include the time of game or time remaining (24), and performance parameters (26) such as the quarter, the down, the number of yards needed for a first down, and the yardage of the line of scrimmage. It will be appreciated that the display fields and the game-specific information displayed by them can be adapted to any particular sport. For example, the display fields of a home scoreboard (10) for baseball might show the inning, the batter count, position of base runners if any, and the like.

In one embodiment, as shown in FIG. 1, the home scoreboard (10) may have a display (28) to show the scores of other games in the same sport, or in other sports. The home scoreboard (10) may also display a news ticker (30) showing general, sports or sport-specific sports news, or other useful information such as weather conditions and forecasts.

In one embodiment, as shown in FIG. 1, the home scoreboard (10) may also display advertising (32). The advertising (32) may be either permanently affixed to the home scoreboard (10) or displayed temporarily as one of the display fields. The use of advertising may permit the home scoreboard (10) to be used as a promotional item, or sold to end-users at reduced prices.

In use, the home scoreboard (10) may be mounted on a wall or displayed on a stand, or otherwise placed in proximity to a television set which is showing a particular sporting event, such as a professional football game. Alternatively, the home scoreboard (10) may be used by a sports fan who is not watching the game live on television, but wishes to receive game information in real-time. Such a fan may be listening to a radio broadcast of the game, or be engaged in some other activity.

As shown in FIG. 1, for example, the game may be between the Pittsburgh Steelers™ and the Oakland Raiders™ of the National Football League™ in the United States. The user may then use a network-connected device such as the home scoreboard (10) itself, a personal computer or a smart phone, to access a website where the user can login with a user name and password to place an order for game-specific data to be sent to the home scoreboard (10) through its network connection. The order is linked to the particular home scoreboard (10) by an identifier associated with the processor (14). For example, in one embodiment, the processor (14) and the WiFi communications link (16) may be implemented using the Electric Imp™ platform, which allows the user to configure the processor (14) using a cloud-based smart phone application.

In one embodiment, the website may implement a subscription model, whereby a user can establish a profile with saved information. In such a case, the user may subscribe to particular events or schedules. For example, a user may subscribe to all Pittsburgh Steelers™ games, which would then obviate the need to login and request a data connection separately for each game.

In one embodiment, the user may be able request information about 2 or more separate simultaneous sporting events, and may then switch between different events using the home scoreboard (10), or another network-connected device.

In another embodiment, the user may implement a time delay. For example, many fans will record a game using a video cassette recorder (VCR), personal video recorder (PVR) or digital video recorder (DVR) in a recorded broadcast file that can be played back at a later time for watching the game. That fan may wish to use the home scoreboard (10) to simulate watching the game live. In one embodiment, the data feed to the home scoreboard may be synchronized to the playback of the recorded broadcast file so that the live viewing experience may be maintained, even while fast forwarding through portions of the broadcast, such as commercial breaks or pausing or rewinding the recording. In one embodiment, the recorded broadcast file may contain inserted game-specific data which is fed to the processor (14) of the home scoreboard (10) to prompt the display of scoreboard events. In one embodiment, the home scoreboard (10) may include a memory component (not shown) for storing the game-specific data and, optionally, the recorded broadcast file. The game-specific data may be recorded by the home scoreboard when the game is played live, or it may receive a game-specific data file, which may be replayed by the processor. The stored game-specific data may then be played back at a later time on the home scoreboard. In one embodiment, the communications link (16) may provide a connection to the playback device to allow the processor (14) to synchronize the playback of the stored game-specific data with the playback of the recorded broadcast file.

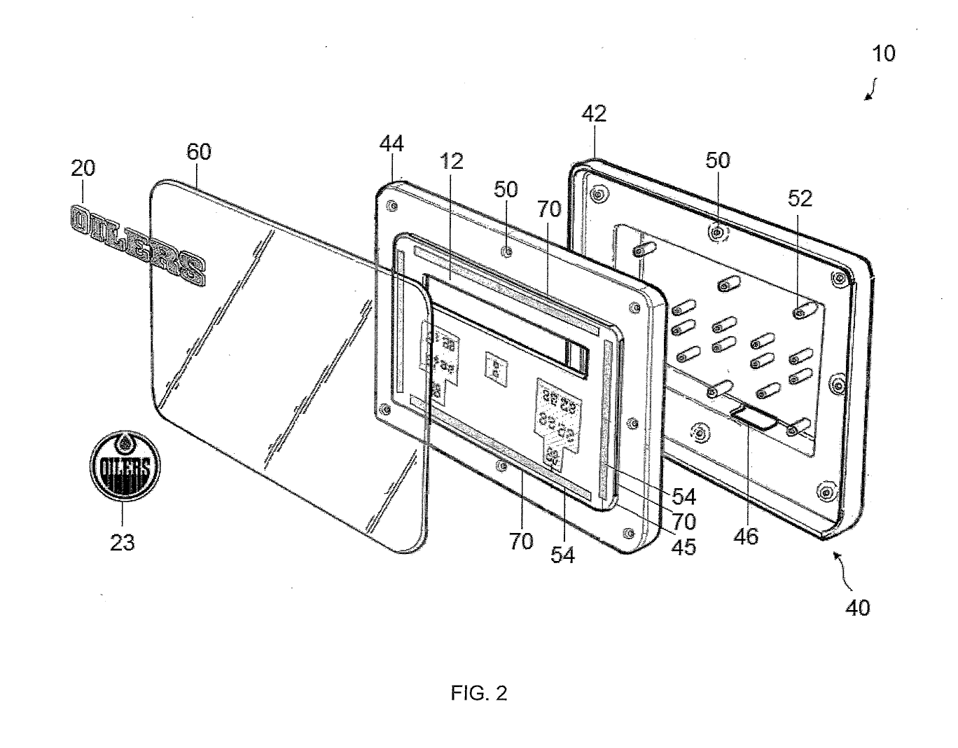

In another embodiment, the processor (14) of the home scoreboard (10) may include functional blocks or modules to monitor the broadcast which is being played and determine scoreboard events from the broadcast. As an example, the processor (14) may execute algorithms to monitor and recognize auditory cues (e.g., word patterns spoken by a sports commentator on a televised sports event) or visual cues (e.g., changes in a time clock or score display as typically shown in a televised sports event) to determine if a scoreboard event has occurred, to generate game-specific data from any such cues, and to display it. In embodiments, as shown in FIGS. 2 through 5, the home scoreboard (10) comprises a housing (40) and a transparent fascia (60). The housing (40) retains the display (12), processor (14) and communications link (16) in a physically integrated unit. The transparent fascia (60) covers the display fields of the display (12), while allowing them to be seen by the user.

In one embodiment, as shown in FIG. 2, the housing (40) comprises a rear housing (42) and a front housing (44), both of which may be made of a suitable metal or plastic, such as injection molded polycarbonate. The rear housing (42) provides a surface for mounting the home scoreboard (10) to a wall, or may include an integrated stand. The rear housing (42) also defines an opening (46) for an electrical cord (48) that provides an AC power input to the display (12), processor (14) and communications link (16). The rear housing (42) and front housing (44) define a plurality of aligned holes (50) with internal female threads to receive therethrough screws that secure the front housing (44) to the rear housing (42). The rear housing (42) also defines a plurality of spaced-apart, internal pegs (52) that prevent the display (12), processor (14) and communications link (16) from moving back-and-forth within the housing (40), while providing clear space around them to dissipate heat.

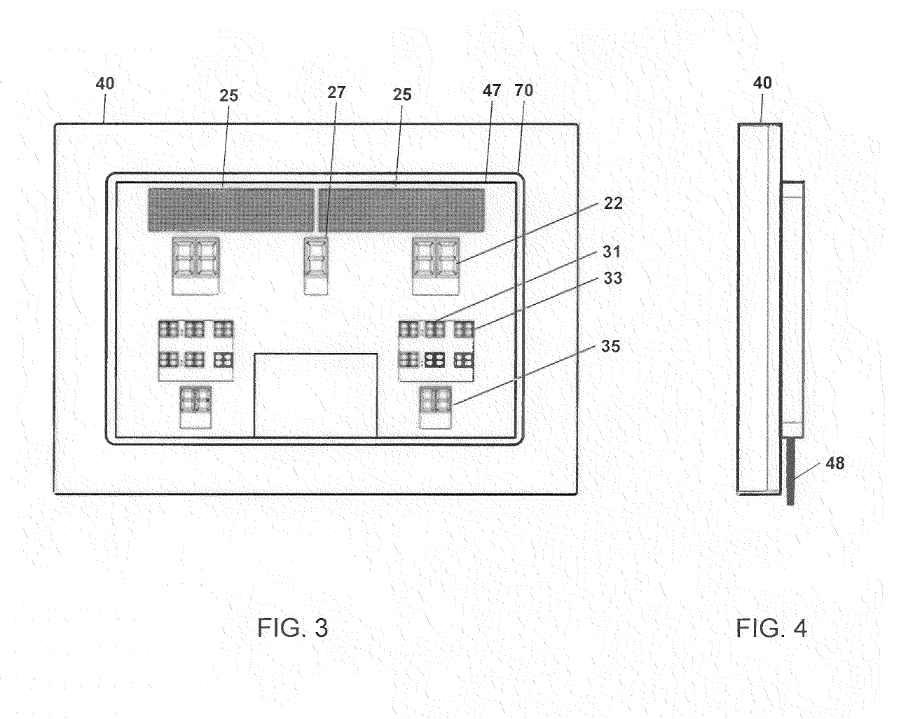

In another embodiment, as shown in FIGS. 3 and 4, the housing (40) comprises a case made of thin gauge sheet metal. The housing (40) defines several internal slots or bays that receive nine displays (12) in the form of LED's, the processor (14) and the communications link (16).

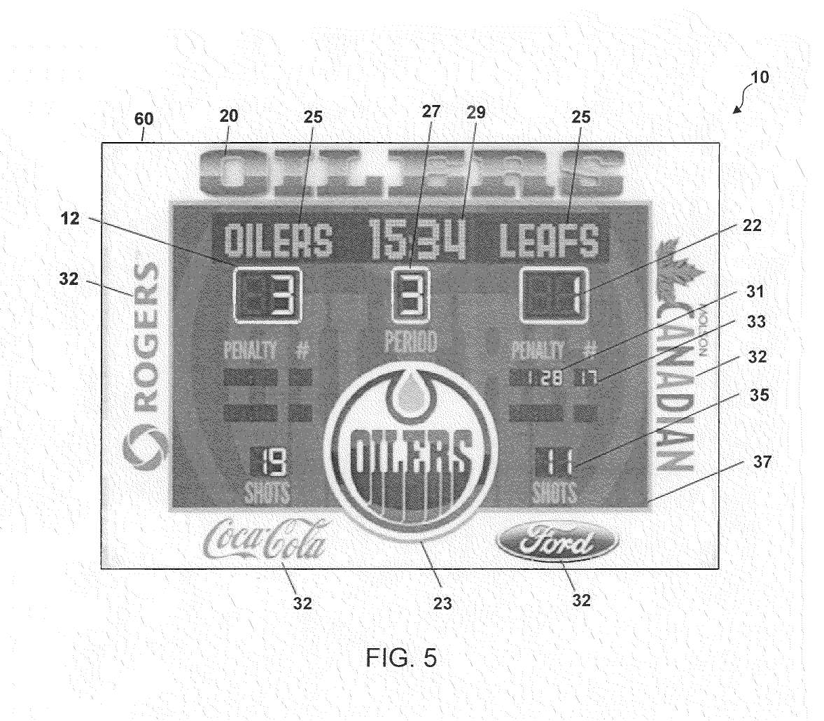

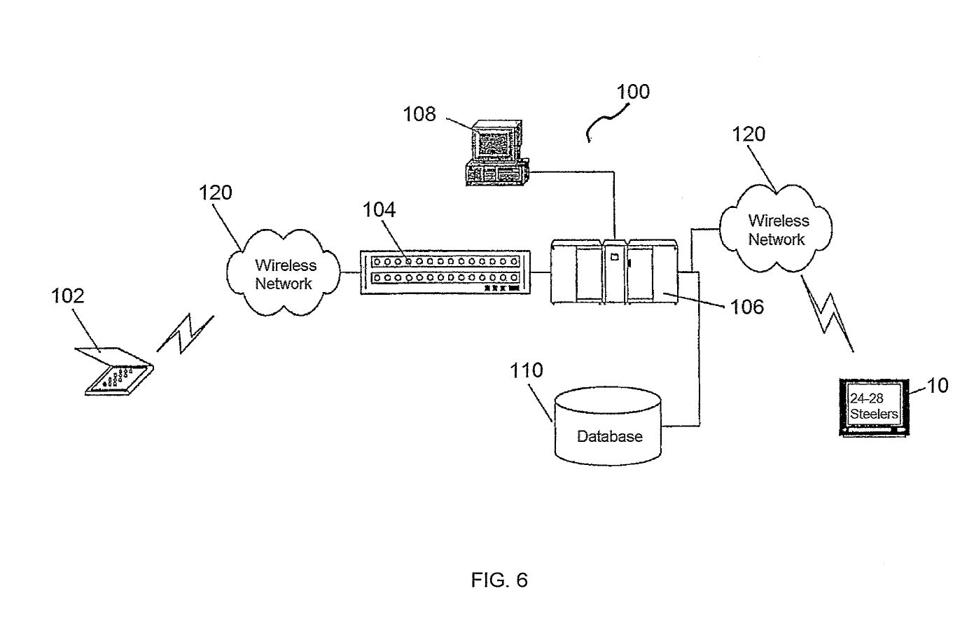

In embodiments, as shown in FIGS. 2 and 5, the transparent fascia (60) is in the form of a plate and is devoid of any openings. The fascia (60) may be made of any suitable transparent material including, without limitation, glass or acrylic marketed as Plexiglas™, Acrylite™, Lucite™ or Perspex™. Thus, the fascia (60) provides an easy-to-clean protective cover for the display (12) underneath.

In one embodiment, as shown in FIG. 2, the fascia (60) is removably secured to the housing (40) by magnets. In particular, magnet strips (not shown) secured to the back of the fascia (60) are attracted to magnet strips (54) secured within recesses formed on the front housing (44). Thus, the fascia (60) may be readily interchanged with another fascia configured for use with a different sport, or a different team. Instead of magnets, any conveniently removable fastener may be used to removably secure the fascia (60) to the housing (40).

The display (12) and fascia (60) may be configured for any sport or team as desired. As an example, in one embodiment as shown in FIGS. 3 and 5, the display and (12) and fascia (60) are configured for hockey game-specific data for the Edmonton Oilers™ of the National Hockey League™. The name (20) and logo (23) of the Edmonton Oilers™ are permanently displayed by 3-dimensional vinyl badges with adhesive backings that are secured to the front side of the fascia (60). In addition, a variety of markings are applied to the rear side of the transparent fascia (60) by any suitable means known in the art such as screen printing, adhesive backed decals, or engraving. These markings include permanently displayed advertising (32), and labels for the display fields, which include the team identifiers (25) (e.g., the team names), the game period (27), the time remaining in the period (29), the time remaining in assessed penalties (31), the number of the player (33) to whom a penalty has been assessed, and the number of shots on goal (35). An opaque mask (37) applied to the reverse side of the fascia (60) conceals much of the underlying housing (40) from frontal view, while leaving transparent portions aligned with the underlying display fields, so that they remain visible to the user,

In one embodiment, the home scoreboard (10) further comprises one or more light sources (70). The light source (70) is operatively connected to the processor (14) so that the light (70) illuminates when the game-specific data is indicative of specified game event. As a non-limiting example, the processor (14) may cause the light source (70) to illuminate when the game-specific data is indicative of a goal being scored. In embodiments, as shown in FIGS. 2 and 3, the light source (70) comprises one or more light emitting diodes (LED) light strips. In the embodiment shown in FIG. 2, the LED light strips (70) are secured to the periphery of a raised portion (45) of the front housing (44). In the embodiments shown in FIG. 3, the LED light strip (70) is secured to the periphery of an internal wall (47) within the housing (40). The opaque mask (37) applied to the fascia (60) conceals the LED light strip (70) from frontal view so that only the glow produced by the light source (70) is visible when illuminated. In one embodiment, the LED light strip (70) comprises a plurality of emitters that emit different colors of light. The processor (14) may be operative to selectively illuminate only certain emitters that emit certain colors of light. As such, the processor (14) may configure the LED light strip (70) to provide a desired lighting color scheme associated with specified game-specific data. For example, selected emitters may be illuminated to produce colors associated with a particular team, or the scoring of a goal by a particular team, or the expiration of a penalty.

In another aspect, as shown in one embodiment in FIG. 2, the present invention provides a system (100) comprising a processor (106, 108) for delivering game-specific data from a database (100) in real-time using a communications link (104) through a wireless network to a home scoreboard (10).

The processor (106, 108) is driven by a set of programmed instructions stored in a memory to receive and process customer orders for game-specific information through a network comprising a wireless network (120), from one of a plurality of network-connected devices (102). In response to such orders, the processor (106, 108) initiates transmissions of game-specific information through a network comprising a wireless network (120), to one of a plurality of home scoreboards (100). In embodiments, the network-connected device (102) may be a cellular telephone, a portable computing device or personal computer. The delivery system (100) and processor (106, 108) may also include functional modules that generate and transmit an invoice to the customer for the order. Alternatively, the modules may add the invoiced amount to the customer's account in the case of periodic invoicing.

The communication link (106) provides a network data connection between the processor (104, 106) and the network devices (102) and the home scoreboards (10). In one embodiment, the communication link (104) may comprise a modem.

The database (110) stores the game-specific information in memory for retrieval and transmission by the processor (106, 108) to the home scoreboards (10). The database (110) may be updated in real-time or, periodically with game-specific information by inputs to the processor (106, 108) or by inputs to another computing device. The database (110) may be maintained physically with the processor (106, 108). Alternatively, the database may be maintained at a remote location from the processor (106, 108) and relay or deliver game-specific data to the system (100) prior to, or simultaneously with, delivery to the home scoreboard (10). After the system (100) receives and processes the order, the wireless network (120) relays the information to the home scoreboard (10) in real-time for immediate viewing, or for storage in a memory operatively connected with the home scoreboard (10) for time-delayed viewing.

As will be apparent to those skilled in the art, various modifications, adaptations and variations of the foregoing specific disclosure can be made without departing from the scope of the invention claimed herein.

What is claimed is:

1. A home scoreboard configured for use in a private residence for receiving game-specific data via a network and displaying the data, the home scoreboard comprising:
(a) a display comprising at least one display field for displaying the data;
(b) a communications link for receiving the data via the network; and
(c) a processor operatively connected to the display, the communications link, and a memory storing a set of instructions, wherein the processor is responsive to the set of instructions to automatically execute a method comprising the steps of:
(i) receiving the data at the processor directly or indirectly from the network; and
(ii) upon receiving the data at the processor, configuring the display to display the data..

2. The home scoreboard of claim 1 further comprising:
(a) a housing that retains the display; and
(b) a fascia covering the display, wherein the fascia comprises at least one transparent portion aligned with the at least one display field to allow the at least one display field to be viewed.

3. The home scoreboard of claim 2 wherein the fascia is removably attached to the housing by a magnet.

4. The home scoreboard of claim 1 further comprising a light source, wherein the processor is operatively connected to the light source, and the method comprises the further step of illuminating the light source in response to receiving data indicative of specified game information.

5. The home scoreboard of claim 1 wherein the light source comprises an LED light strip.

6. The home scoreboard of claim 5 wherein the LED light strip comprises a plurality of emitters that emit light of different colors, and wherein the processor selectively illuminates emitters depending on the data.

7. The home scoreboard of claim 1 wherein the step of receiving the data at the processor comprises receiving the data directly from the network via the communications link,

8. The home scoreboard of claim 1 wherein the received data is stored in a memory component for replay at a later time, and the processor is operatively linked by the communications link to a video recording and playback device to synchronize the replay of the stored data and the playback of a recorded game broadcast.

9. The home scoreboard of claim 1 wherein the step of receiving the data at the processor comprises receiving the data indirectly from the network by analyzing a recorded broadcast file for any auditory or visual cues indicative of the data and generating the data from the cues, upon playback of the recorded broadcast file originally transmitted via the network.

10. A system for delivering game-specific over a network from a database to a home scoreboard in response to an order from a network-connected device, the order being linked to the home scoreboard, the system comprising:
(a) a processor operatively connected to the network and the database; and
(b) a memory storing a set of instructions, wherein the processor is responsive to the set of instructions to automatically execute a method comprising the steps of:
(i) receiving the order for the data via the network;
(ii) in response to the order, retrieving the data from the database; and
(iii) transmitting the data via the network, directly or indirectly, to the home scoreboard in real-time to its reception.

11. The system of claim 10 wherein the method comprises the further steps of generating an invoice for the order and transmitting the invoice via the network to the network-connected device.

12. The system of the claim 10 wherein the step of transmitting the data via the network comprises transmitting a broadcast file containing the data.

13. A method of providing game-specific data over a network to a customer, the method implemented by a processor connected to the network and comprising the steps of:
(a) receiving an order for game-specific data from a network-connected device;
(b) in response to the order, retrieving the data from a database; and
(c) transmitting the data, directly or indirectly, to a home scoreboard linked to the order.

14. The method of claim 13 wherein the method comprises the further steps of generating an invoice for the order and transmitting the invoice via the network to the network-connected device.

15. The method of claim 13 wherein the step of transmitting the data via the network comprises transmitting a broadcast file containing the data.
